(19) United States
(12) Patent Application Publication
(10) Pub. No.: US 2006/0026874 A1
(43) Pub. Date: Feb. 9, 2006

(54) Inflatable lighted seasonal display

(76) Inventor: Kuo-Jui Wei, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/910,299

(22) Filed: Aug. 4, 2004

(51) Int. Cl. G09F 13/00

(52) U.S. Cl. 40/442

(57) ABSTRACT

An inflatable lighted seasonal display includes a costume, an air-filled inner body, a weighted base or an inflating pump set, light-emitting devices, lighted decorative elements, ring supports and a power supply device. The costume has a zipper. The air-filled inner body is installed inside the costume through the zipper, and the air-filled inner body has an air valve placed thereon. The light-emitting device and the lighted decorative elements are attached on the costume. The power supply device is installed in the costume and electrically connects to the light-emitting devices and the inflating pump set.

### BACKGROUND OF THE INVENTION

1. Field of the Invention

The present invention relates to an inflatable lighted seasonal display, and especially to an inflatable lighted seasonal display that can be easily inflatable when in use and deflated when not in use so that it is easy and convenient for user to carry, display and store, and that the cost of shipment is more cheaper.

2. Description of Related Art

In general, the inflatable lighted seasonal display of the prior art is filled with stuffs each as cottons or foam rubbers inside, and the shape of the prior art will be fixed and limited by the stuffs so that it is not convenient for user to carry, display and store, and that the cost of shipment is more expensive.

### SUMMARY OF THE INVENTION

The primary object of the present invention is to provide an inflatable lighted seasonal display, which can be easily inflatable when in use and deflated when not in use so that it can be carried, displayed and stored easily by user.

The secondary object of the present invention is to provide an inflatable lighted seasonal display, which occupies little space during shipment and the cost of the shipment will be more cheaper.

In order to achieve the above objects, the present invention provides an inflatable lighted seasonal display comprising a costume, an air-filled inner body, a weighted base, lighted decorative elements, at least one light-emitting device and a power supply device.

The costume has a closure placed thereon. The air-filled inner body is installed inside the costume, and has an air valve placed thereon. The weighted base is mounted inside at the bottom side of the air-filled inner body. The lighted decorative elements are attached on the costume, and at least one light-emitting device is installed in the costume for mating with the lighted decorative elements. The power supply device is installed in the costume and is electrically connected to the light-emitting device.

In order to achieve the above objects, the present invention provides an inflatable lighted seasonal display comprising a costume, an air-filled inner body, an inflating pump set, lighted decorative elements, at least one light-emitting device and a power supply device.

The costume has a first hole and a closure placed thereon. The air-filled inner body is installed inside the costume, and has a second hole placed thereon and corresponding to the first hole, and an air valve placed thereon. The inflating pump set has a pressure sensor mounted inside at the bottom side of the air-filled inner body. The lighted decorative elements are attached on the costume, and at least one light-emitting device is installed in the costume for mating with the lighted decorative elements. The power supply device is installed in the costume and is electrically connected to the light-emitting device and the inflating pump set.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawing, in which:

FIG. 1 is a perspective view of a first embodiment of the present invention;

FIG. 2 is a perspective view of a second embodiment of the present invention;

FIG. 3 is a perspective view of a third embodiment of the present invention;

FIG. 4 is a perspective view of a fourth embodiment of the present invention;

FIG. 5 is a perspective view of a fifth embodiment of the present invention;

FIG. 6 is a perspective view of a sixth embodiment of the present invention; and

FIG. 7 is a partial cross-sectional view of a seventh embodiment of the present invention.

### DETAILED DESCRIPTION OF PREFERRED EMBODIMENTS

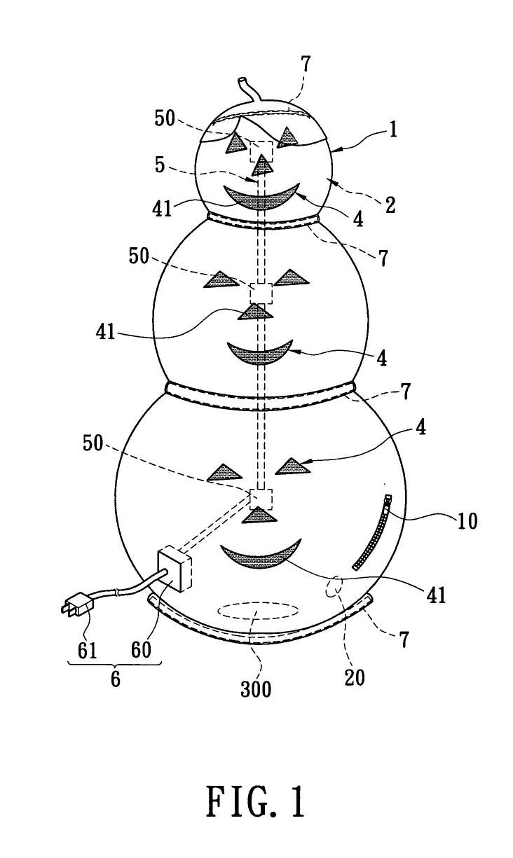

FIG. 1 shows a perspective view of a first embodiment of the present invention. Referring to FIG. 1, the present invention provides a inflatable lighted seasonal display comprising a costume 1, an air-filled inner body 2, a weighted base 300, lighted decorative elements 4, light-emitting devices 5, a power supply device 6 and ring supports 7.

The costume 1 has a closure 10 (as a zipper) placed thereon, and the air-filled inner body 2 is stored inside the costume 1 and has an air valve 20 (as an intake or outtake) placed thereon. When the air-filled inner body 2 is inflated, the costume 1 will be expanded for display. When the air-filled inner body 2 exhausts through the air valve 20, the costume 1 and the air-filled inner body 2 will collapse together. In other words, when the air-filled inner body 2 is full of air, the costume 1 can be changed into any shapes for display; and when the air-filled inner body 2 exhausts through the air valve 20, the inflatable lighted seasonal display will collapse and it can be easy and convenient for user to carry, display and store, and the cost of shipment is more cheaper.

The weighted base 300 is mounted inside at the bottom side of the air-filled inner body 2 for keeping the inflatable lighted seasonal display balanced as an easily tipped toy that quickly rights itself.

The lighted decorative elements 4 are attached on the costume 1. Each of the lighted decorative elements 4 has punched holes 41 or notched points formed thereon.

The light-emitting devices 5 are installed in the costume 1 for mating with the lighted decorative elements 4. The light-emitting device 5 has a light source 50 attached to the inside surface of the costume 1. Wherein the light source is a light bulb or a LED lamp.

The power supply device 6 is installed in the costume 1 and is electrically connected to the light-emitting device 5. The power supply device 6 includes a wire reel box 60 installed in the costume 1, and has one side connecting to a plug 61. Wherein the wire reel box 60 is used to extend the wire at a predetermined length and to return the wire to the wire reel box 60.

The ring supports 7 are separately installed to one another inside the costume 1 in series for holding the shape of the costume 1. When the air-filled inner body 2 exhausts through the air valve 20, the inflatable lighted seasonal display folds to a storeable item.

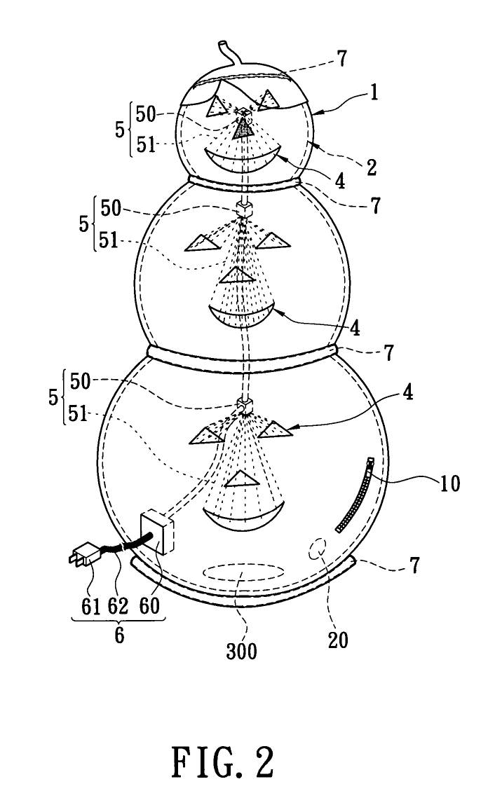

FIG. 2 shows a perspective view of a second embodiment of the present invention. The light-emitting device 5 has a light source 50, and fiber optical bunches 51 connecting to the light source 50 and attached on the inside surface of the costume 1. Furthermore, the power supply device 6 further comprises a coiled wire 62 connected between the wire reel box 60 and the plug 61.

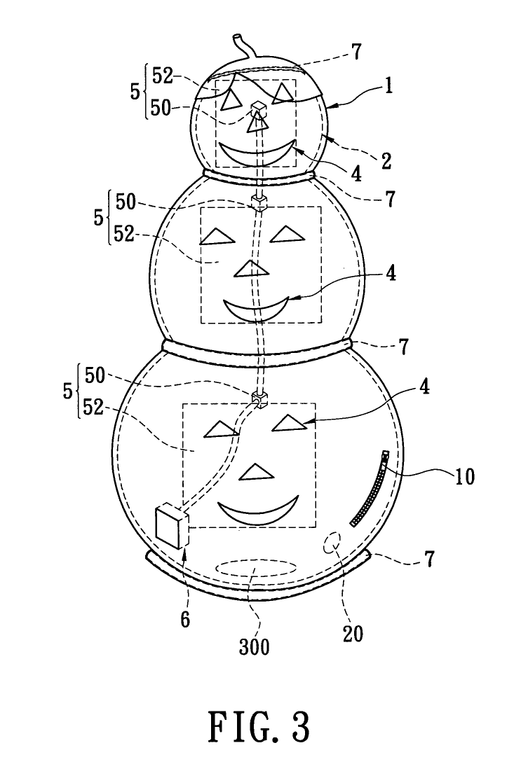

FIG. 3 shows a perspective view of a third embodiment of the present invention. The light-emitting device 5 has a light source 50, and light-guiding plates 52 connecting to the light source 50 and attached on the inside surface of the costume 1. Furthermore, the power supply device 6 is a battery.

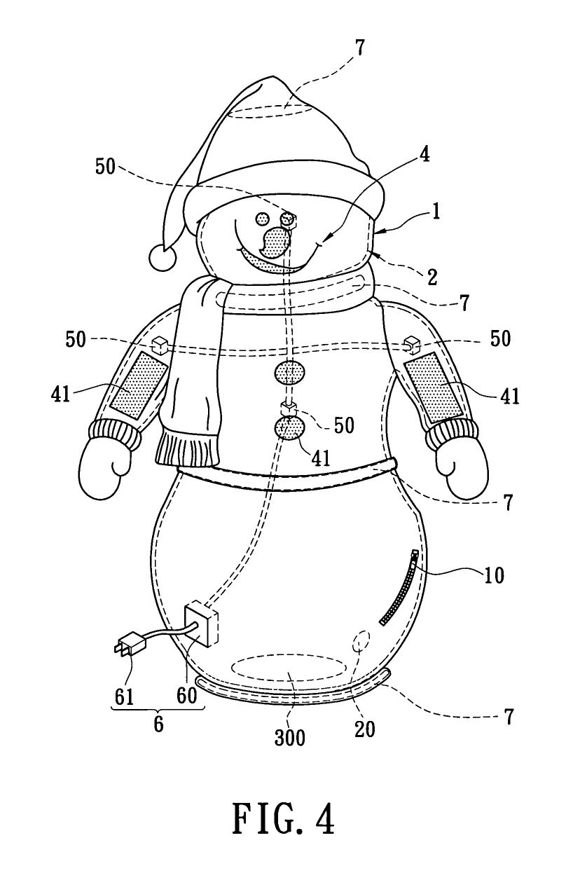

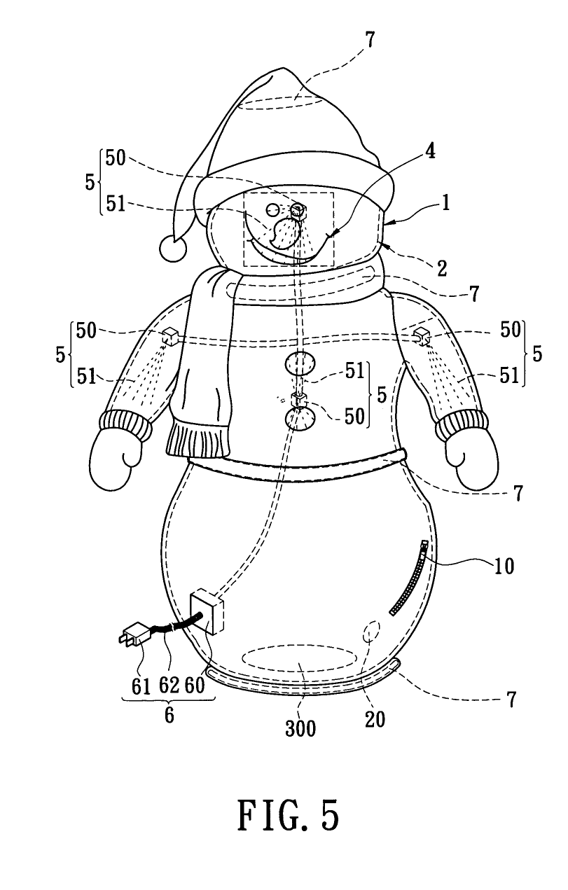

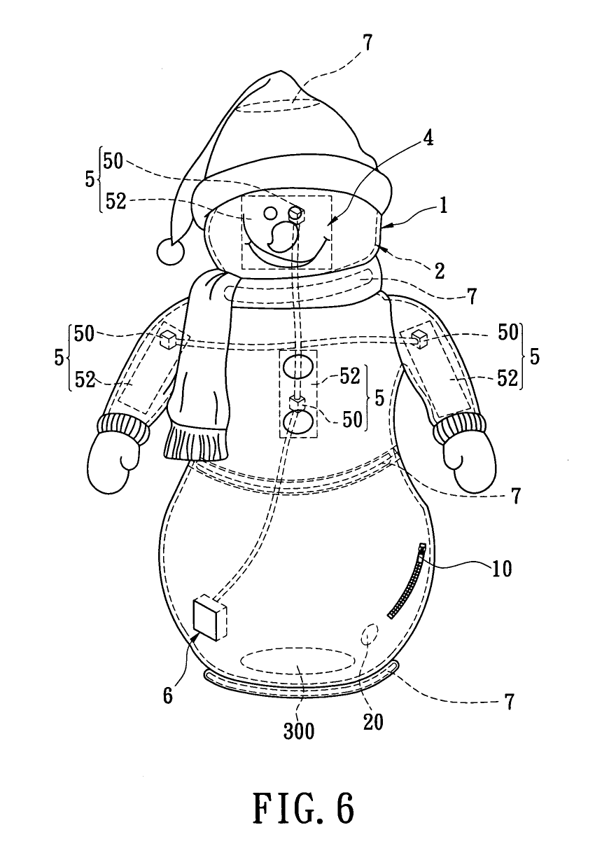

FIG. 4 shows a perspective view of a fourth embodiment that is similar to the disclosure of FIG. 1 except the shape of the costume 1. FIG. 5 shows a perspective view of a fifth embodiment that is similar to the disclosure of FIG. 2 except the shape of the costume 1, and FIG. 6 shows a perspective view of a sixth embodiment that is similar to the disclosure of FIG. 3 except the shape of the costume 1.

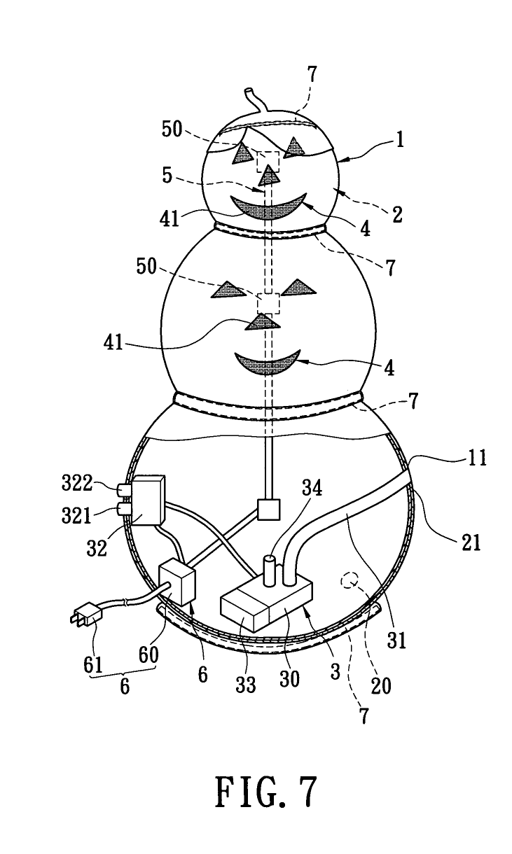

FIG. 7 shows a partial cross-sectional view of a seventh embodiment of the present invention. Referring to FIG. 7, the present invention further comprises an inflating pump set 3 having a pressure sensor 33 mounted inside at the bottom side of the air-filled inner body 2. Moreover, the costume 1 further includes a first hole 11 placed thereon, and the air-filled inner body further includes a second hole 21 placed thereon and corresponding to the first hole 11.

The inflating pump set 3 has an air pump 30, an air intake duct 31, an air outtake duct 34 and a switch 32. The air intake duct 31 is connected to outside world through the first hole 11 and the second hole 21 for guiding the air into the air pump 30. The air outtake duct 34 is connected with the air pump 30 for guiding the air into the air-filled inner body 2. The switch 32 includes a turning on button 321 electrically connecting to the air pump 30 by an electric wire (no label), and a turning off button 322. When the user presses the turning on button 321, the power supply device will supply power to the air pump 30 for driving the air pump 30 to running. When the user presses the turning off button 322, the air pump 30 will stop the running.

Although the present invention has been described in some detail by way of illustration and example for purposes of clarity and understanding, it will of course be understood that various changes and modifications may be made in the form, details and arrangements of the parts without departing from the scope of the invention as set forth in the following claims.

What is claimed is:

1. An inflatable lighted seasonal display comprising:
a costume having a closure placed thereon;
an air-filled inner body installed inside the costume, and having an air valve placed thereon;
a weighted base mounted inside at a bottom side of the air-filled inner body;
lighted decorative elements attached on the costume;
at least one light-emitting device installed in the costume for mating with the lighted decorative elements; and
a power supply device installed in the costume and electrically connected to the light-emitting device.

2. The inflatable lighted seasonal display as claimed in claim 1, wherein the light-emitting device has a light source, and fiber optical bunches or a light-guiding plate connecting to the light source and attached on an inside surface of the costume.

3. The inflatable lighted seasonal display as claimed in claim 2, wherein the light source is a light bulb or a LED lamp.

4. The inflatable lighted seasonal display as claimed in claim 1, wherein each of the lighted decorative elements has punched holes or notched points formed thereon.

5. The inflatable lighted seasonal display as claimed in claim 1, wherein the power supply device includes a wire reel box installed in the costume, and the wire reel box has one side connecting to a plug.

6. The inflatable lighted seasonal display as claimed in claim 1, wherein the power supply device has a coiled wire with one side connecting to a plug.

7. The inflatable lighted seasonal display as claimed in claim 1, wherein the power supply device is a battery.

8. The inflatable lighted seasonal display as claimed in claim 1, further comprising ring supports separately installed inside the costume in series.

9. An inflatable lighted seasonal display comprising:
a costume having a first hole and a closure placed thereon;
an air-filled inner body installed inside the costume, and having a second hole placed thereon and corresponding to the first hole, and an air valve placed thereon;
an inflating pump set having a pressure sensor mounted inside at a bottom side of the air-filled inner body;
lighted decorative elements attached on the costume;
at least one light-emitting device installed in the costume for mating with the lighted decorative elements; and
a power supply device installed in the costume and electrically connected to the light-emitting device, and the inflating pump set.

10. The inflatable lighted seasonal display as claimed in claim 9, wherein the inflating pump set has an air pump, an air intake duct connecting to outside world through the first hole and the second hole, an air outtake duct connecting to the air pump, and a switch electrically connecting to the air pump.

11. The inflatable lighted seasonal display as claimed in claim 10, wherein the switch has a turning on button electrically connecting to the air pump by an electric wire, and a turning off button.

12. The inflatable lighted seasonal display as claimed in claim 9, wherein the light-emitting device has a light source, and fiber optical bunches or a light-guiding plate connecting to the light source and attached to an inside surface of the costume.

13. The inflatable lighted seasonal display as claimed in claim 12, wherein the light source is a light bulb or a LED lamp.

14. The inflatable lighted seasonal display as claimed in claim 9, wherein each of the lighted decorative elements has punched holes or notched points formed thereon.

15. The inflatable lighted seasonal display as claimed in claim 9, wherein the power supply device includes a wire reel box installed in the costume, and the wire reel box has one side connecting to a plug.

16. The inflatable lighted seasonal display as claimed in claim 9, wherein the power supply device has a coiled wire with one side connecting to a plug.

17. The inflatable lighted seasonal display as claimed in claim 9, wherein the power supply device is a battery.

18. The inflatable lighted seasonal display as claimed in claim 1, further comprising ring supports separately installed inside the costume in series.
